(19) United States
(12) Patent Application Publication
(10) Pub. No.: US 2012/0007741 A1
(43) Pub. Date: Jan. 12, 2012

(54) Auto Reminder

(76) Inventors: Joseph Francis Laffey, SR., Bensalem, PA (US); Suzanne Laffey, Bensalem, PA (US)

(21) Appl. No.: 12/833,762

(22) Filed: Jul. 9, 2010

(51) Int. Cl. G08B 23/00

(52) U.S. Cl. 340/573.1

(57) ABSTRACT

Apparatus for warning a driver of a car that a child, pet or valuable is still in the car when an attempt is made by the driver to lock the car doors after the car is parked and the engine is turned off comprising a keyless remote entry device having a door unlocking button and a door locking button; at least one button on the keyless remote entry device which, when first pressed, shows that a child, pet or valuable is being placed in the car; a control circuit coupled to the keyless remote entry device; and an alarm circuit controlled by the control circuit; wherein the keyless remote entry device cannot be used to lock the car doors when a child, pet or valuable is still in the car after the car engine is turned off and the button has not been pressed a second time to alert the remote entry device that the child, pet or valuable has been removed from the car.

### BACKGROUND OF THE INVENTION

1. Field of the Invention

The present invention relates generally to apparatus and method for reminding a driver of a car that a child, a pet and/or a valuable is in a parked car and, more particularly to a safety device which saves lives by providing a keyless remote entry device with at least one button which, when first pressed indicates that a child, pet and/or a valuable is being placed in the car for transportation. Upon arrival at a destination the keyless remote entry device cannot be used to lock the car doors if the child, pet or valuable is still in the car after the car engine is turned off and the button first pressed has not been pressed a second time to alert the remote entry device that the child, pet or valuable has been removed from the car.

2. Description of Related Art

On hectic and busy days, it can be very easy for adults to experience momentary confusion and lapses in judgment. Juggling the sometimes daunting demands of career and family, parents can be particularly susceptible to this, despite their best intentions and diligence. Rushing from work to collect children from school or day care, a parent may have to complete a plethora of other errands before finally reaching home, such as making a bank deposit or picking up a few items from the market for dinner. In a hurry, the parent may consider it safe to leave a child in the car while quickly dashing into an establishment, or they may be so harried that they leave the child behind without realizing they have done so.

Unfortunately, leaving a child or a pet alone in a car, even for a short period of time, can lead to tragic circumstances, especially on hot days. As disturbing as the thought may be, the facts are indisputable. All it takes is a few minutes for the temperature inside a car, even with the windows cracked, to rise to dangerous levels. According to experts, even on a mild day at 73 degrees F. outside, an SUV can heat up to 100 degrees F. in 10 minutes and up to 120 degrees F. in just 30 minutes. As the outdoor temperature rises, so does the heat buildup in a vehicle. At 90 degrees F. outside, the interior of a vehicle can heat up to 160 degrees F. within several minutes. Children's developing respiratory system makes them particularly vulnerable to heat exhaustion. As the heat rises, their body temperatures rise. An infant in a parked car in 110 degree F. heat can get in trouble quickly. Infants tend to heat up very quickly, rapidly approaching the temperature of their environment. Sadly, 32 children nationally died from heat in 2007 as a result of having been left alone in motor vehicles.

Apparatus for warning when a child has been left in an infant seat in a parked car with the engine turned off is known in the prior art. More specifically, by way of example, U.S. PreGrant Publication No. 2008/0100431 to Monzo; et al. discloses a sensing device to detect if a child is in the infant seat, an ignition detection device to detect that the ignition is off, a delay timer to provide a certain period of time for the caregiver to remove the child from the car seat or put the child in the infant/booster seat and then to generate an alarm, a speaker to sound the alarm.

U.S. PreGrant Publication No. 2007/0279206 to Singfield discloses a safety device, which assists parents in locating their child, should their child be taken while in their vehicle, or stroller. In addition, this device serves as a safety tool which reminds the parent that the child is in the car, by playing a voice activated alert, or alert preprogrammed by the system, through a timed system preference setting.

U.S. Pat. No. 7,250,869 to Davis discloses a first sensor for sensing the presence of at least one of a child and infant. A means for detecting the operative mode of a vehicle engine is connected to the first sensor. A means for indicating the presence to a third party is connected to the first sensor. The indicating means is activated and indicates to the third party the presence of a child and infant upon the detecting means detecting that the vehicle engine is off and the first sensor sensing the presence of the at least one child and infant.

U.S. Pat. No. 7,012,533 to Younse discloses a child car seat with a built-in cushion switch that closes when the seat is occupied. Also, push type switches are added to at least one of the vehicle's side passenger doors with signals being routed to a micro-controller unit, which determines when the car seat is occupied and when one of the doors is open and enables the vehicle's internal beeper alarm, thereby reminding any occupants exiting the vehicle that a child is strapped in the back seat. Additionally, an inside temperature sensor sets off a loud external alarm when the temperature inside the vehicle goes above or below a safe preprogrammed environmental range.

U.S. Pat. No. 6,924,742 to Mesina discloses a seat belt alarm system which activates an alarm when a child is buckled in a car seat and when the car key is removed from the ignition. The seat belt alarm system includes a belt buckle having a belt-buckled sensor and a transmitter that transmits a belt-buckled signal when the belt is buckled. A remote key module includes a key-removed sensor that senses when the key is not in a keyhole.

U.S. Pat. No. 6,922,147 to Viksnins, et al. discloses a child occupant sensor having an input to detect a child in the child car seat, and an output which provides a signal representative of whether a child is present in the child car seat. The temperature sensor detects an ambient vehicle temperature. An alarm provides a warning using information about whether the child is present in the child car seat and the ambient vehicle temperature is outside an acceptable range.

U.S. Pat. No. 6,714,132 to Edwards, et al. discloses a system to alert a caregiver that an object or person has been left unattended. A detector senses the presence a child in a safety seat. The transmitter transmits a wireless signal when the object is in position. The receiver, which is remotely located from the transmitter, senses the signal as long as the receiver is within a prescribed range of transmission. The system communicates an alarm to the caregiver when the caregiver ventures outside the range of transmission without having removed the object/child from the position.

U.S. Pat. No. 6,535,137 to Ryan discloses an alarm in a seat buckle. The alarm includes a pair of speakers for broadcasting an audible alarm. The alarm is activated when the male buckle is in the female receptacle, and the alarm is deactivated when the male buckle is removed from the female receptacle. The alarm is in communication with an electrical system of the vehicle whereby a shut down of the motor vehicle's engine or an opening of a driver's door will sound the alarm when the alarm is in an activated orientation.

U.S. Pat. No. 6,104,293 to Rossi discloses a apparatus for warning when a child has been left in an infant seat and a vehicle as been turned off. The apparatus includes an occupant detection mechanism for detecting the presence of an occupant within an infant seat; an ignition detection mechanism for detecting the state of the vehicle's ignition system; a control unit for generating an alarm signal when the occupant detection mechanism detects the presence of an occupant within the infant seat and the ignition detection mechanism detects that the vehicle's ignition system has been turned from an “on” state to an “off” state; and an alarm units for generating an alarm in response to the alarm signal.

U.S. Pat. No. 5,966,070 to Thornton discloses an alarm system for detecting the presence of a child locked within a parked automobile during extreme temperatures. The alarm system includes a temperature detecting element and a child detecting element electrically coupled to an AND gate. The temperature detecting element transmits an extreme temperature signal to the AND gate if the temperature within the automobile exceeds a pre-selected maximum temperature. The child detecting element transmits a child detection signal to the AND gate when it detects a child within the automobile. The AND gate, upon receiving both the child detection signal and the extreme temperature signal, transmits and alarm signal.

### SUMMARY OF THE INVENTION

The keyless remote entry device for a car having a door locking button for locking the doors of a car and a door unlocking button for unlocking the doors of the car also includes additional buttons having icons or symbols which designate a child, a pet and/or valuables. In addition to the keyless remote entry device, a monitor which can be located in the instrument panel or on the dashboard of the car also includes the icons of a child, a pet and valuables.

A driver, before entering his/her car, presses the door unlocking button on the keyless remote entry device and then presses any one or combination of three icon buttons to designate who or what is being placed into the car by the driver.

The driver then places the child, pet and/or valuable into the car and starts the car engine. At this time the screen of the monitor in the car is activated and the icon(s) of the button(s) on the keyless remote entry device pressed prior to entering the car light up to indicate who and/or what the driver indicated was being placed into the car. The monitor may also have voice capability and will announce who and/or what the driver indicated was being placed into the car.

When the driver reaches his/'her destination, parks the car and places the shift lever in the park position, the screen of the display monitor will visually and verbally remind the driver to remove who and/or what was placed into the car and should now be removed.

After removing the child, pet and/or valuable from the car, the button(s) on the keyless remote entry device which were first pressed when the driver entered the car is now pressed a second time to let The Auto Reminder know that the child, pet and/or valuable which was placed into the car at the beginning of the car ride has been removed. If the button(s) on the keyless remote entry device are not pressed a second time to indicate that the child, pet and/or valuables have been removed prior to pressing the door locking button on the keyless device, the keyless remote entry device will begin to blink and vibrate for a short period of time and then the car lights and/or horn will flash and sound to remind the driver that the child, pet and/or valuables have not been removed from the car. The lights will flash and the horn will sound until the driver removes the child, pet and/or valuables and then again presses the button(s) on the remote keyless entry device a second time.

In an exemplary embodiment of the present invention, there is disclosed apparatus for warning a driver of a car that a child, a pet or a valuable is still in the car when an attempt is made by the driver to lock the car doors after the car is parked and the engine is turned off comprising;
a keyless remote entry device having a door unlocking button and a door locking button;
at least one additional button on the keyless remote entry device which, when first pressed, shows that a child, a pet or a valuable is being placed in the car;
a control circuit coupled to the keyless remote entry device; and
an alarm circuit controlled by the control circuit;
wherein the keyless remote entry device cannot be used to lock the car doors if the child, pet or valuable is still in the car after the car engine is turned off and the button which was first pressed has not been pressed a second time to alert the remote entry device that the child, pet or valuable has been removed from the car.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a view of a manufacture's original equipment control module which is adapted to be a part of the instrument panel of a car or mounted in the dash board of a car;

FIG. 2 is a view of an after market/portable control module which can be mounted, with a bracket or strips of Velcro to the dash board of a car;

FIG. 3 is a view of the car keyless remote entry device; and

FIG. 4 is a block diagram showing portions of a control module for sounding an alarm when the engine of a car has been turned off and an attempt is made to lock the doors when a child, a pet, and/or a valuable has been inadvertently left in the car after the shift lever of the car has been placed in park and the driver attempts to lock the car doors.

### DESCRIPTION OF THE PREFERRED EMBODIMENT

The present invention of The Auto Reminder is a sound and sight reminder which alerts a driver of a car that a child, a pet and/or a valuable has been accidentally left in a parked car after the engine has been turned off and the driver is attempting to lock the car doors.

Designed as an after market product or as part of original equipment manufacture, The Auto Reminder is comprised of a transmitting unit that can be installed within the keyless remote entry device and configured to operate with that unit's lock/unlock capabilities. In addition a small, liquid crystal display having a baby icon, a pet icon and a valuable icon such as a dollar sign ($) can be located on the front of the keyless remote entry device to serve as a control and a visual indicator that, upon entering the car, the system has been activated to indicate that a child, pet and/'or a valuable is being placed in the car. A speaker or a vibrator can be located within the keyless remote entry device's durable plastic housing to provide a warning when the driver attempts to lock the car doors before removing the child, pet and/or valuable from the car. Audio and visual alerts can also be incorporated into the screen of the monitor in the car's instrument panel and the lights and horn of the car.

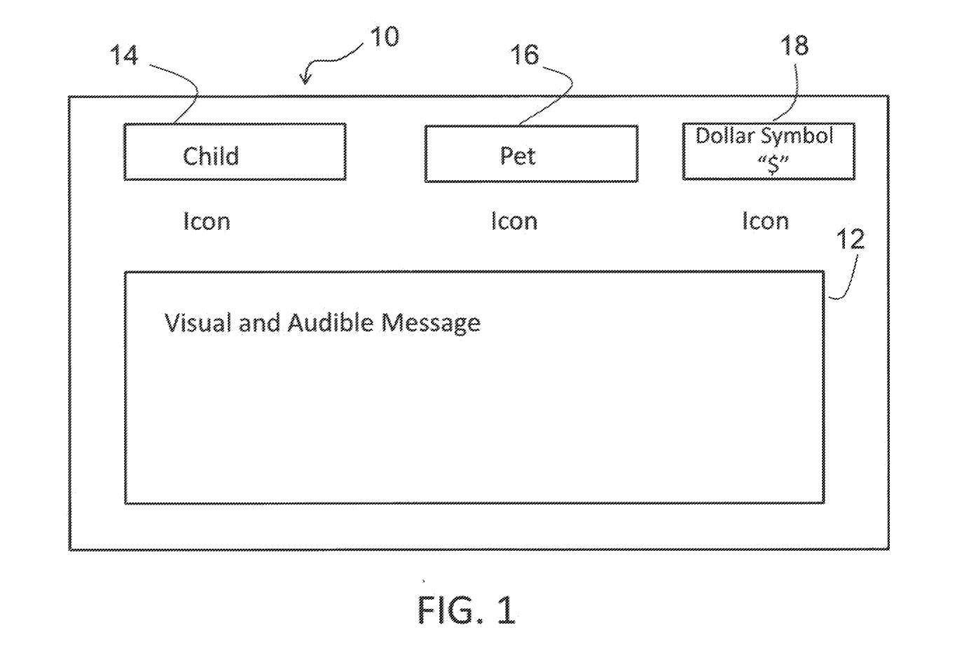

Referring to FIG. 1, there is disclosed a view of a manufacture's original equipment control module which is adapted to be mounted in the instrument panel or in the dash board of a car. The control module 10 can have a screen 12 for displaying a message and an icon 14 of a child. When the button on the keyless remote entry device is first pressed the system is activated, and when the button is pressed a second time the system is deactivated. If the button is not pressed a second time to tell the keyless remote entry device that the child has been removed from the car after the engine has been turned off and before the driver attempts to lock the car doors, the keyless remote entry device cannot be used to lock the car doors and an alarm will alert the driver of the car that the child is still in the car.

Icon 16 can be of a pet. When the button on the keyless remote entry device for a pet is first pressed the system is activated, and when the button is pressed a second time the system is deactivated. If the button is not pressed a second time to tell the keyless remote entry device that the pet has been removed from the car after the engine has been turned off and before the driver attempts to lock the car doors, the keyless remote entry device cannot be used to lock the car doors and an alarm will alert the driver of the car that the pet is still in the car.

Icon 18 can be of a valuable such as a dollar symbol $. When the button on the keyless remote entry device for a valuable is first pressed the system is activated, and when the button is pressed a second time the system is deactivated. If the button is not pressed a second time to tell the keyless remote entry device that the valuable has been removed from the car after the engine has been turned off and before the driver attempts to lock the car doors, the keyless remote entry device cannot be used to lock the car doors and an alarm will alert the driver of the car that the valuable is still in the car.

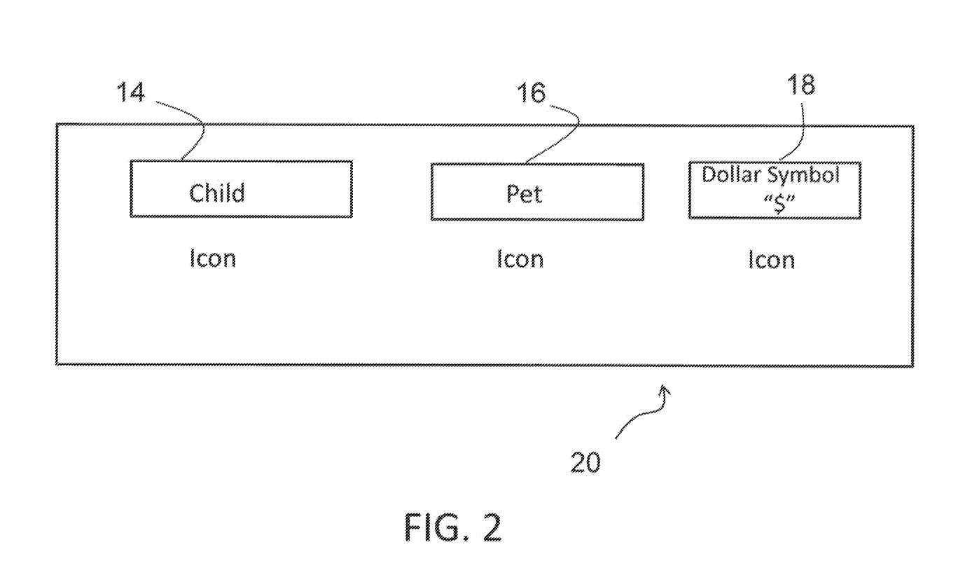

Referring to FIG. 2, there is shown a view of an after market/portable control module 20 which can be mounted, with a bracket, strips of Velcro etc. to the dash board of a car for operation by the car driver. The control module has icons of a child 14, a pet 16, and a valuable 18 such as a dollar symbol $. The control module can be made of a durable plastic which can be powered by rechargeable batteries or with an extension cord that plugs into the car cigarette lighter.

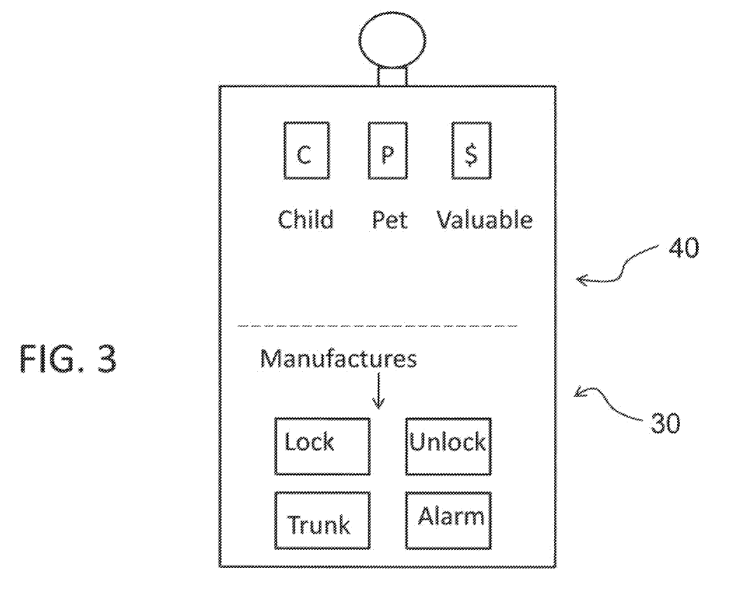

Referring to FIG. 3, there is shown a view of the keyless remote entry device for a car having the usual manufacture's provided functions 30 of lock, unlock, trunk and alarm in addition to the functions 40 of setting the system of The Auto Reminder here disclosed to indicate that a child, a pet and/or a valuable is still in the car if the driver attempts to lock the car doors after the car is parked and before the child, pet and/or valuable has been removed from the car. In addition the keyless remote entry device can have a display screen (not shown) and a small speaker (not shown) to provide visual and audio messages to the car driver.

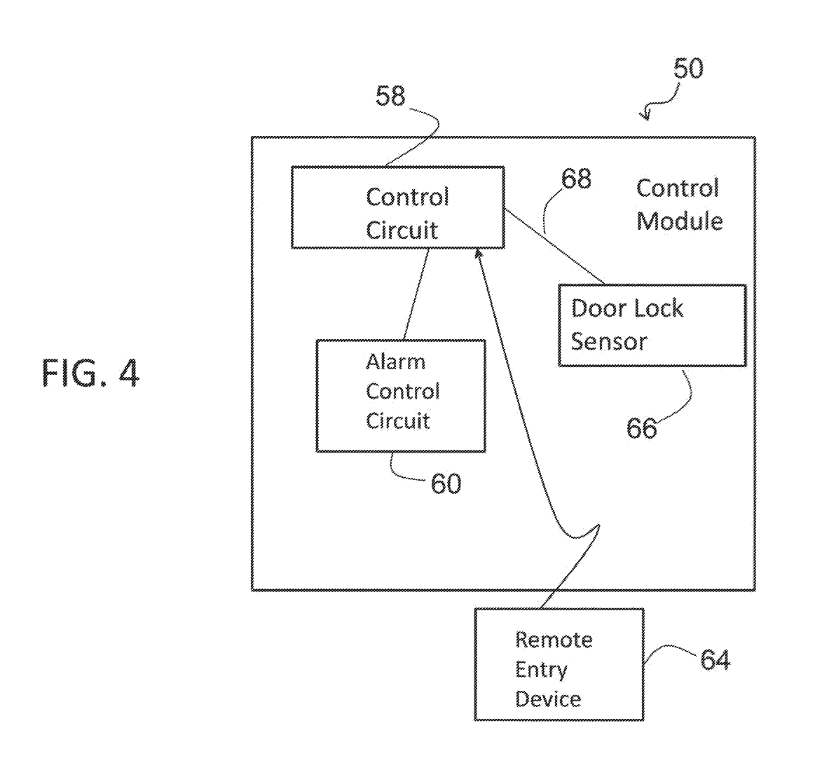

Referring to FIG. 4, there is shown a block diagram of a control module for generating an alarm, either audible, visual or both, when the engine of a car has been turned off and the driver steps out of the car and attempts to lock the car doors while a child, a pet and/or a valuable has been inadvertently left in the car

The block diagram of the control module 50 can include at least a control circuit 58, an alarm control circuit 60 and a door lock sensor 66.

The control circuit 58 is provided to generate a signal which is fed to the alarm control circuit 60 when a child, a pet and/or a valuable is still in the car after the engine is turned off, the shift lever is placed in park and the driver is trying to lock the doors with the remote entry device 64. Door lock sensor 66 is provided to generate a signal via conductor 68 which indicates that the doors of the car are being locked by the keyless remote entry device.

When a driver parks his/her car, turns off the engine, leaves the car and tries to lock the car doors with the remote entry device before removing the child, the pet and/or the valuable, and before pressing the appropriate icon button on the keyless remote entry device, the doors of the car will not lock and the car lights will sound and/or the car horn will sound intermittently. In addition a buzzer or vibrator will be activated and a voice or a beeping sound will be generated by a speaker in the remote entry device to alert the driver that the car doors will not lock and that a child, a pet, and/or a valuable is still in the car. In the event the driver ignores the alert from the keyless remote entry device and starts to walk away from the car, a timer which counts down from, for example 30 seconds, will operate the horn and/or the lights of the car which will continue to operate until the child, pet and/or valuable is removed from the car and the appropriate icon button(s) on the keyless remote entry device is pressed.

In operation, a person before entering his/her car, presses the door unlocking button and then presses any one or combination of three icon buttons on the keyless remote entry device to designate that a child, a pet and/or a valuable is being place in the car.

The driver then places the child, pet and/or valuable into the car and starts the car. At this time the screen of the monitor in the car is activated and the icon(s) of the buttons pressed prior to entering the car light up to indicate who and/or what the driver indicated was being placed into the car. The monitor may have voice capability and will announce who and/or what the driver placed into the car.

When the driver reaches his/'her destination, parks the car and places the shift lever in the park position, the screen of the display monitor will visually and verbally remind the driver to remove who and/or what was placed into the car and should now be removed.

After removing the child, pet and/or valuable from the car, the button(s) on the keyless remote entry device is pressed a second time by the driver to alert The Auto Reminder that the child, pet and/or valuable which was placed into the car at the beginning of the car ride has been removed. If the icon button(s) on the keyless remote entry device is not pressed a second time to indicate that the child, pet and/or valuables has been removed from the car prior to pressing the door locking button on the keyless device, the keyless device will vibrate, flash and/or verbally alert the driver that the child, pet and/or valuable is still in the car. If this alert warning is ignored by the driver, after a preset interval of time which can vary from five seconds to forty five seconds, the car head lights will flash and/or the horn will sound to more positively remind the driver that the child, pet and/or valuable has not been removed from the car. The lights will flash and the horn will sound until the driver removes the child, pet and/or valuable and then presses the appropriate button(s) on the remote keyless entry device a second time.

When a user has driven to a chosen destination, turns the car engine off and attempts to lock the car doors before pressing the first pressed button a second time, the remote entry device will begin vibrating or making a buzzing sound to alert the driver that a child, a pet or a valuable is still in the car. Should the driver ignore this warning, the horn will sound and/or headlights of the car will flash after a brief interval of time until the child, pet and/or valuable is removed from the car and the appropriate icon button on the keyless remote entry device is pressed.

The auto reminder of the present invention affords consumers several significant benefits and advantages. Foremost, the auto reminder is a safety device which can save lives by effectively preventing rushed and harried parents from unintentionally leaving behind a helpless child in a car. While adults would never willfully put their loved ones at risk, the auto reminder provides a way for them to avoid accidentally leaving a child at the mercy of a hot, airless vehicle.

With the auto reminder a forgetful adult is served with a clear reminder, both visually and audibly, that they forgot to remove a child, pet and/or valuable from the car.

Offered in new cars and as a system that can be easily retrofitted into used cars, parents and caregivers the world over will be able to keep their children and pets safe from being left behind in a car.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. Apparatus for warning a driver of a car that a child, a pet or a valuable is still in the car when an attempt is made by the driver to lock the car doors after the car is parked and the engine is turned off comprising;
a keyless remote entry device having a door unlocking button and a door locking button;
at least one button on the keyless remote entry device which, when first pressed, shows that a child, a pet or a valuable is being placed in the car;
a control circuit coupled to the keyless remote entry device; and
an alarm circuit controlled by the control circuit;
wherein the keyless remote entry device cannot be used to lock the car doors when a child, pet or a valuable is still in the car after the car engine is turned off and the at least one button has not been pressed a second time to alert the remote entry device that the child, pet or valuable has been removed from the car.

2. The apparatus of claim 1 wherein the at least one button includes a button for a child and a button for a pet, wherein the keyless remote entry device cannot be used to lock the car doors when a child or pet is still in the car after the car engine is turned off and the button which was first pressed has not been pressed a second time to alert the remote entry device that the child or pet has been removed from the car.

3. The apparatus of claim 1 wherein the at least one button includes a button for a child and a button for a valuable wherein the keyless remote entry device cannot be used to lock the car doors when a child or valuable is still in the car after the car engine is turned off and the button which was first pressed has not been pressed a second time to alert the remote entry device that the child or valuable has been removed from the car.

4. The apparatus of claim 1 wherein a buzzer is located in the keyless remote entry device which sounds an alarm when an attempt is made to lock the car doors prior to removing the child, pet or valuable after the car engine has been turned off and before the at least one button which was first pressed has not been pressed a second time to alert the remote entry device that the child, pet or valuable has been removed from the car.

5. The apparatus of claim 4 wherein the keyless remote entry has a display that shows which button has been pressed.

6. The apparatus of claim 4 wherein lights on the keyless remote entry begin to flash when an attempt is made to lock the car doors prior to removing the child, pet or valuable after the car engine has been turned off and before the at least one button has not been pressed a second time to alert the remote entry device that the child, pet or valuable has been removed from the car.

7. The apparatus of claim 4 wherein a count down timer causes the car horn to sound if the button which was first pressed is not pressed a second time before the count down timer reaches the end of its time.

8. The apparatus of claim 4 wherein a count down timer causes the car headlight to flash if the button which was first pressed is not pressed a second time before the count down timer reaches the end of its time.

9. The apparatus of claim 4 wherein a monitor which is a part of the instrument panel of the car or is attached to the dashboard of the car is activated when the car engine is turned on to show icon(s) of the button(s) pressed prior to entering the car to indicate who or what the driver indicated was being placed into the car.

10. A method for warning a driver of a car that a child, a pet or a valuable is still in the car when an attempt is made by the driver to lock the car doors after the car is parked and the engine is turned off comprises;
providing a keyless remote entry device having a door unlocking button and a door locking button;
providing at least one button on the keyless remote entry device which, when first pressed, indicates that a child, a pet or a valuable is being placed in the car;
coupling a control circuit to the keyless remote entry device; and
providing an alarm circuit controlled by the control circuit;
wherein the keyless remote entry device cannot be used to lock the car doors when a child, pet or valuable is still in the car after the car engine is turned off and the at least one button has not been pressed a second time to alert the remote entry device that the child, pet or valuable has been removed from the car.

11. The method of claim 10 wherein the at least one button includes a button for a child and a button for a pet wherein the keyless remote entry device cannot be used to lock the car doors when a child or pet is still in the car after the car engine is turned off and the at least one button which was first pressed has not been pressed a second time to alert the remote entry device that the child or pet has been removed from the car.

12. The method of claim 10 wherein the at least one button includes a button for a child and a button for a valuable wherein the keyless remote entry device cannot be used to lock the car doors when a child or valuable is still in the car after the car engine is turned off and the at least one button which was first pressed has not been pressed a second time to alert the remote entry device that the child or valuable has been removed from the car.

13. The method of claim 10 wherein a buzzer is located in the keyless remote entry device which sounds an alarm when an attempt is made to lock the car doors prior to removing the child, pet or valuable after the car engine has been turned off and before the at least one button has not been pressed a second time to alert the remote entry device that the child, pet or valuable has been removed from the car.

14. The method of claim 13 wherein the keyless remote entry has a display that shows which button has been pressed.

15. The method of claim 13 wherein lights on the keyless remote entry begin to flash when an attempt is made to lock the car doors prior to removing the child, pet or valuable after the car engine has been turned off and before the at least one button has not been pressed a second time to alert the remote entry device that the child, pet or valuable has been removed from the car.

16. The method of claim 13 wherein a count down timer causes the car horn to sound if the button which was first pressed is not pressed a second time before the count down timer reaches the end of its time.

17. The method of claim 13 wherein a count down timer causes the car headlight to flash if the button which was first pressed is not pressed a second time before the count down timer reaches the end of its time.

18. The method of claim 13 wherein a monitor which is a part of the instrument panel of the car or attached to the dashboard of the car is activated when the car engine is turned on to show icon(s) of the button(s) pressed prior to entering the car to indicate who or what the driver indicated was being placed into the car.
